(19) United States
(12) Patent Application Publication
(10) Pub. No.: US 2026/0334364 A1
(43) Pub. Date: Oct. 29, 2026

(54) Cotton Harvester Lubrication System

(71) Applicant: DEERE & COMPANY, MOLINE, IL (US)

(72) Inventor: BING HUI DONG, ANKENY, IA (US)

(21) Appl. No.: 19/632,867

(22) Filed: Mar. 30, 2026

Related U.S. Application Data
(60) Provisional application No. 63/796,818, filed on Apr. 29, 2025.
(60) Provisional application No. 63/905,855, filed on Oct. 27, 2025.

(51) Int. Cl. A01D 46/08

(52) U.S. Cl. CPC A01D 46/088

(57) ABSTRACT

A lubrication system for a cotton harvester includes an inlet configured to receive lubricant from an external source, a cap removably coupled to the inlet, a reservoir configured to store the lubricant. The lubrication system further includes a fill valve having a first end and a second end. The second end of the fill valve is coupled to the reservoir, a strainer having a first end coupled to the inlet and a second end coupled to the first end of the fill valve, and a supply valve having a first end coupled to the first end of the strainer and a second end configured to receive grease from the reservoir.

### CROSS-REFERENCE TO RELATED APPLICATIONS

This application claims the benefit of U.S. Provisional Application No. 63/796,818 filed Apr. 29, 2025 and U.S. Provisional Application No. 63/905,855 filed Oct. 27, 2025. The entire disclosures of the applications referenced above are incorporated by reference.

### FIELD

The present disclosure relates to cotton harvesters, and in particular, to grease straining systems for cotton pickers.

### BACKGROUND

A cotton picker is an agricultural machine designed for harvesting cotton plants in a field. The cotton picker may include one or more heads or units for performing the harvesting operation. Each of the one or more heads or units includes a number of spindles and doffers for harvesting the cotton plants. Doffer columns have a plurality of doffers for removing picked cotton from the spindles. A doffer is a disc that may be coated in rubber or urethane and rotatably driven at a velocity much greater than that of the spindles. In a conventional cotton picker row unit, the spindles move below a bottom face of the doffers so that the cotton is unwrapped and stripped from the spindles. In some conventional systems, a doffer drive system is mechanically driven off a spindle drive system, or at the very least the two systems are mechanically coupled to one another.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A lubrication system for a cotton harvester includes an inlet configured to receive lubricant from an external source, a cap removably coupled to the inlet, a reservoir configured to store the lubricant. The lubrication system further includes a fill valve having a first end and a second end. The second end of the fill valve is coupled to the reservoir, a strainer having a first end coupled to the inlet and a second end coupled to the first end of the fill valve, and a supply valve having a first end coupled to the first end of the strainer and a second end configured to receive grease from the reservoir.

In other features, the lubrication system includes a service valve having a first port coupled to the reservoir and a second port coupled to the second end of the supply valve.

In other features, the fill valve is configured to (i) permit a flow of fluid from the first end of the fill valve to the second end of the fill valve and (ii) restrict the flow of fluid from the second end of the fill valve to the first end of the fill valve.

In other features, the supply valve is configured to (i) permit a flow of fluid from the first end of the supply valve to the second end of the supply valve and (ii) restrict the flow of fluid from the second end of the supply valve to the first end of the supply valve.

In other features, the lubrication system includes a pump (i) having an inlet coupled to the second end of the strainer and (ii) configured to supply the grease to a plurality of picking units of the cotton harvester.

In other features, the fill valve includes a first spring loaded check valve. In further features, the inlet includes a second spring loaded check valve.

In yet further features, the first spring loaded check valve has a first cracking pressure, the second spring loaded check valve has a second cracking pressure, and the second cracking pressure is greater than the first cracking pressure.

In other features, the first cracking pressure is 1 pound per square inch (PSI).

In other features, the second cracking pressure is 20-30 pounds per square inch (PSI).

In other features, the strainer includes a Y-strainer. In further features, the Y-strainer includes a drain.

A method of operating a lubrication system of a cotton harvester having a plurality of picking units, a reservoir, and a pump configured to draw grease from the reservoir and supply it to the plurality of picking units includes opening a service valve coupled to the reservoir, removing a cap covering an inlet, opening a bleeder valve of the pump, and adding the grease to the reservoir via the inlet.

In other features, the method includes monitoring an output of the bleeder valve, closing, in response to determining that the output is a steady stream, the bleeder valve, monitoring a level of grease in the reservoir, and in response to determining that the level is equal to a threshold value, (i) discontinuing the addition of grease via the inlet and (ii) affixing the cap to the inlet.

A cotton harvester includes a plurality of picking units, an inlet configured to receive grease from an external source, a cap removably coupled to the inlet, and a reservoir configured to store the grease. The cotton harvester further includes a fill valve having a first end and a second end. The second end of the fill valve is coupled to the reservoir, a strainer having a first end coupled to the inlet and a second end coupled to the first end of the fill valve, a supply valve having a first end coupled to the first end of the strainer and a second end configured to receive grease from the reservoir, and a pump (i) having an inlet coupled to the second end of the strainer and (ii) configured to supply the grease to the plurality of picking units.

In other features, the cotton harvester includes a service valve having a first port coupled to the reservoir and a second port coupled to the second end of the supply valve.

In further features, the fill valve includes a first spring loaded check valve and the inlet includes a second spring loaded check valve.

In yet further features, the first spring loaded check valve has a first cracking pressure, the second spring loaded check valve has a second cracking pressure, and the second cracking pressure is greater than the first cracking pressure.

In other features, the second cracking pressure is 20-30 pounds per square inch (PSI).

In other features, the strainer includes a Y-strainer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a sideview of an example cotton harvester including a grease straining system according to the principles of the present disclosure.

FIG. 2 is a schematic of an example lubrication system for a multi-head agricultural machine according to the principles of the present disclosure.

FIG. 3 is a functional block diagram of an example implementation of a grease straining system according to the principles of the present disclosure.

FIG. 4 is an illustration of the example implementation of a grease straining system of FIG. 3.

FIG. 5 is a flowchart of example operations of loading grease into the grease straining system of FIG. 3.

In the drawings, reference numbers may be reused to identify similar and/or identical elements.

### DETAILED DESCRIPTION

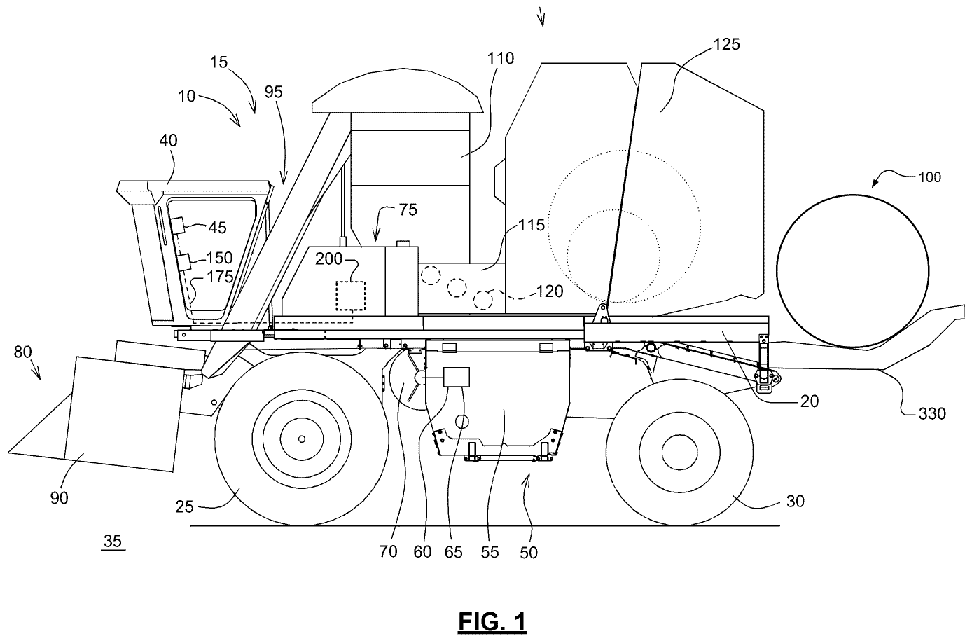

FIG. 1 illustrates an example cotton picker 15—e.g., a cotton harvester. The cotton picker 15 includes a chassis 20. The illustrated chassis 20 is supported by front ground engaging members 25 and rear ground engaging members 30. Although the front ground engaging members 25 and rear ground engaging members 30 of the cotton picker 15 are depicted as wheels, other supports are contemplated—for example, tracks. The cotton picker 15 is adapted for movement through a field 35 to harvest cotton. An operator station 40 is supported by the chassis 20.

An operator interface 45 is positioned in the operator station 40. In some implementations, the operator interface 45 includes a display screen—for example, a liquid crystal display (LCD), a light emitting diode (LED) screen, an organic LED (OLED) screen, or a CRT display. The display screen of the operator interface 45 may present, via a graphical user interface (GUI), various features and/or parameters of the cotton picker 15. In various implementations, the operator interface 45 may include one or more user input devices—for example, buttons, switches, touch screens, and/or levers. The operator of the cotton picker 15 may adjust various operating parameters of the cotton picker 15 via the operator interface 45—for example, by actuating one or more of the user input devices.

A power module 50 may be supported below the chassis 20. The power module may be an engine 55 that drives a hydraulic motor 60 or a mechanical drive 65 to power a variable pitch fan 70. An operator may set a minimum power for the power module 50 from the operator interface 45. The operator may also set a minimum engine speed from the operator interface 45. Water, lubricant, and fuel tanks, indicated generally at 75, may be supported on the chassis 20.

A harvesting structure 80 is coupleable to the chassis 20. The harvesting structure 80 is configured to remove cotton from the field 35 and includes a plurality of cotton picking units 90.

An air duct system 95 is coupleable to the harvesting structure 80. A round module builder 105 is coupleable to the air duct system 95. The round module builder 105 includes an accumulator 110 that is configured to receive cotton harvested by the cotton-picking units 90.

With continued reference to FIG. 1, a feeder 115 is coupleable to the chassis 20. The feeder 115 is configured to receive cotton from the accumulator 110. The feeder 115 includes a plurality of rollers 120 configured to compress the cotton and transfer the cotton to a baler 125 of the round module builder 105.

As shown in FIG. 1, the cotton picker 15 includes a lubrication system 200 and a greasing control module 150. The lubrication system 200 supplies a lubricant—e.g., grease—to one or more cotton picker units 90 of the cotton picker 15. The operator interface 45, the lubrication system 200, and the greasing control module 150 may exchange data—for example, parameters and instructions—via a network 175, such as a controller area network (CAN). The network 175 may include one or more data buses.

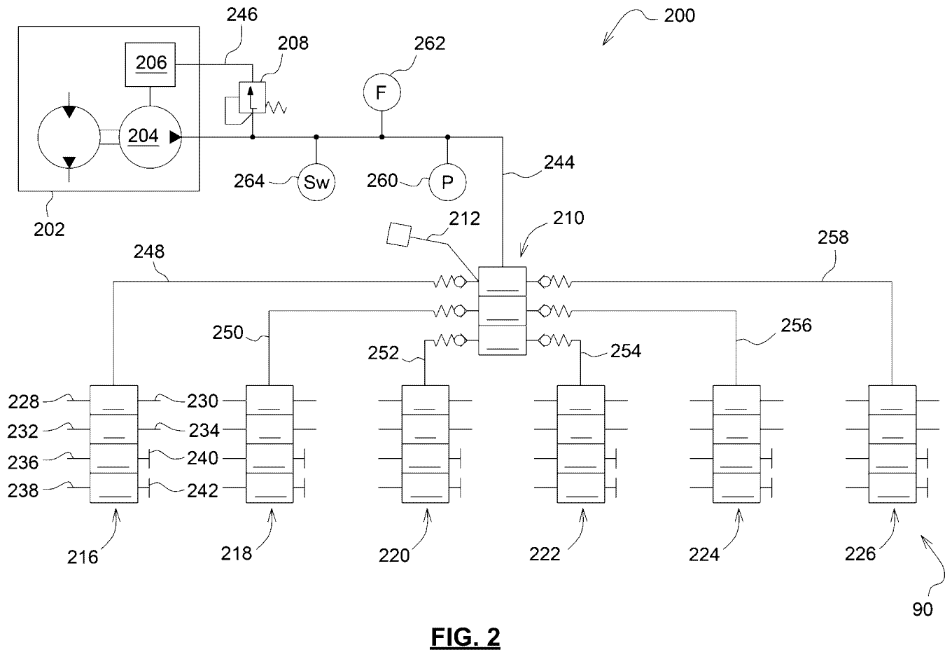

Referring to FIGS. 1 and 2, the lubrication system 200 includes a lubrication or grease pump system 202 for supplying a lubricant to one or more heads or cotton picker units 90 of the cotton picker 15. In the system 200 of FIG. 2, multiple cotton picker units 90 are shown. Specifically, six cotton picker units 90 are shown. For example, the agricultural machine includes a first picker unit 216, a second picker unit 218, a third picker unit 220, a fourth picker unit 222, a fifth picker unit 224, and a sixth picker unit 226. The lubrication system 200 is designed to provide the lubricant from the pump system 202 to each cotton picker unit 90, as described below.

The pump system 202 includes a pump 204 and a reservoir 206. The reservoir 206 stores the lubricant and is fluidly coupled to the pump 204. The pump 204 supplies the lubricant into a supply line 244. A pressure limiting valve 208 is located downstream of the pump 204 and fluidly coupled to the reservoir 206 via a return line 246. In other implementations, a pressure sensor and pressure switch may be used. In some implementations, a pressure limiting valve 208 as well as a pressure switch and/or pressure sensor may be used. In some implementations, the pump 204 includes a bleeder valve, not shown.

As shown in FIG. 2, the lubricant is supplied via the supply line 244 through a filter 262 or strainer. A pressure sensor 260 and pressure switch 264 are located downstream of the pump 204 along the supply line 244. The pressure switch 264 is located upstream of the filter 262 and is configured to detect a flow blockage or restriction in the filter 262. The pressure sensor 260 is located downstream of the filter 262 and is configured to sense fluid or lubricant pressure in the supply line 244. Other arrangements of the pressure switch 264 and pressure sensor 260 are possible in other implementations. For example, in some implementations, the pressure sensor 260 and pressure switch 264 may be located upstream of the filter 262. In other implementations, the pressure sensor 260 and pressure switch 264 may be located downstream of the filter 262. In yet another implementation, there may be one or more pressure sensors 260 and pressure switches 264 located upstream and/or downstream of the filter 262. Although not shown in FIG. 2, each pressure sensor 260 and pressure switch 264 may be in communication with a controller or control system—for example, the greasing control module 150—to communicate signals thereto.

The lubricant is supplied via the pump 204 through the supply line 244 to a primary distributor 210 located downstream of the pump system 202. The primary distributor 210, also referred to as a progressive distributor, is configured to sequentially distribute lubricant to each cotton picker unit 90. More specifically, the primary distributor 210 is configured to distribute a specific volume of lubricant to the first picker unit 216, then the second picker unit 218, the third picker unit 220, and so forth. During operation, the primary distributor 210 ensures that per cycle, each picker unit receives the same volume of lubricant as the other picker units. Thus, the lubrication system 200 of FIG. 2 is not a restriction-based lubrication system. Instead, the primary distributor 210 includes a sensor such as a proximity switch 212 that is configured to count cycles. The proximity switch 212 may be used to determine how much or what volume of lubricant is distributed to each picker unit. Moreover, the proximity switch 212 may be used to determine how many cycles are needed to achieve a threshold or sufficient amount of lubrication at each picker unit. The proximity switch 212 is not affected by temperature variations in the lubricant, but instead counts or detects a number of cycles lubrication is distributed to each picker unit.

A plurality of fluid lines or hoses are coupled to the primary distributor 210 for supplying fluid downstream of the primary distributor 210 and to one of the plurality of cotton picker units 90. For example, a first fluid line 248 is coupled to the primary distributor 210 and supplies lubricant to the first picker unit 216. A second fluid line 250 of the plurality of fluid lines is coupled to the primary distributor 210 and supplies lubricant to the second picker unit 218. A third fluid line 252 of the plurality of fluid lines is coupled to the primary distributor 210 and supplies lubricant to the third picker unit 220. A fourth fluid line 254 of the plurality of fluid lines is coupled to the primary distributor 210 and supplies lubricant to the fourth picker unit 222. A fifth fluid line 256 of the plurality of fluid lines is coupled to the primary distributor 210 and supplies lubricant to the fifth picker unit 224. A sixth fluid line 258 of the plurality of fluid lines is coupled to the primary distributor 210 and supplies lubricant to the sixth picker unit 226.

A plurality of check valves may also be incorporated into the different fluid lines downstream of the primary distributor 210. For example, a first check valve is fluidly disposed between the primary distributor 210 and the first fluid line 254. The first check valve is configured to prevent a backflow of lubricant to the primary distributor 210. Similarly, a second check valve is fluidly disposed between the primary distributor 210 and the second fluid line 256. A third check valve and fourth check valve 406 are fluidly disposed between the primary distributor 210 and the third fluid line 258 and fourth fluid line 248, respectively. Moreover, a fifth check valve and sixth check valve are fluidly disposed between the primary distributor 210 and the fifth fluid line 250 and the sixth fluid line 252, respectively. Each fluid line of the plurality of fluid lines is therefore fluidly coupled to a different port associated with the primary distributor 210. The primary distributor 210 may include additional ports to which a fluid line or hose is not connected. For example, in the implementation of FIG. 2, a first port 240 and a second port 242 are blocked off so that lubricant is not dispensed from the primary distributor 210 through either port.

As lubricant is distributed via the primary distributor 210 to each cotton picker unit 90, the lubricant is supplied through a corresponding fluid line (e.g., the first fluid line 254) to a secondary distributor. In one implementation, each picker unit includes its own secondary distributor. In other implementations, two or more picker units may be fluidly coupled to the same secondary distributor. In some implementations, the secondary distributor is the same as or common to each of the picker units. In other implementations, the second distributor is the same for at least two or more of the cotton picker units 90.

In several implementations, the primary distributor is specific to a particular agricultural machine and the number of picker units coupled to the machine. For example, in one implementation, an agricultural machine having four picker units may utilize one primary distributor, whereas an agricultural machine having six picker units may utilize a different primary distributor. In some implementations, each machine may include only one primary distributor and a plurality of secondary distributors for each picker unit. In other implementations, each machine may include two or more primary distributors. In a further implementation, an agricultural machine may include a plurality of primary distributors and a plurality of secondary distributors in the lubrication system. In FIG. 2, each cotton picker unit is shown including its own secondary distributor.

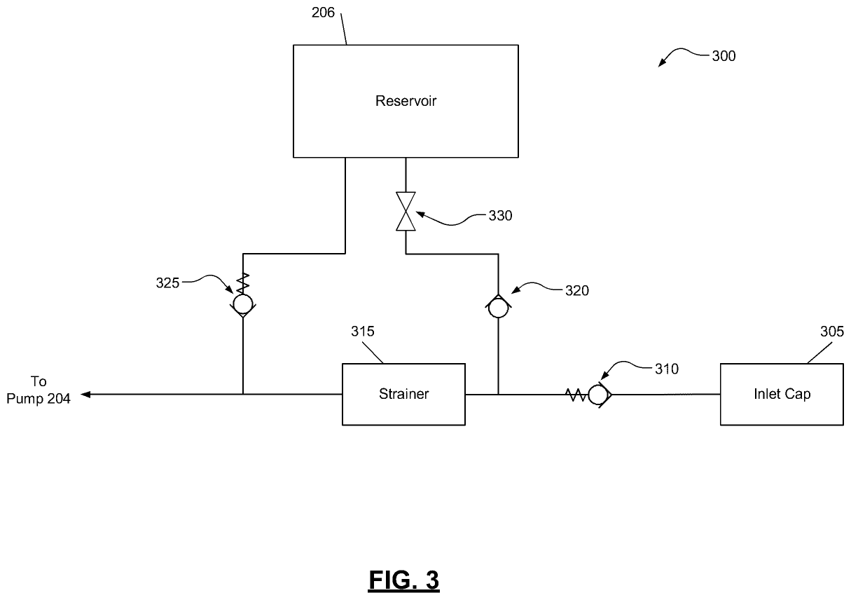

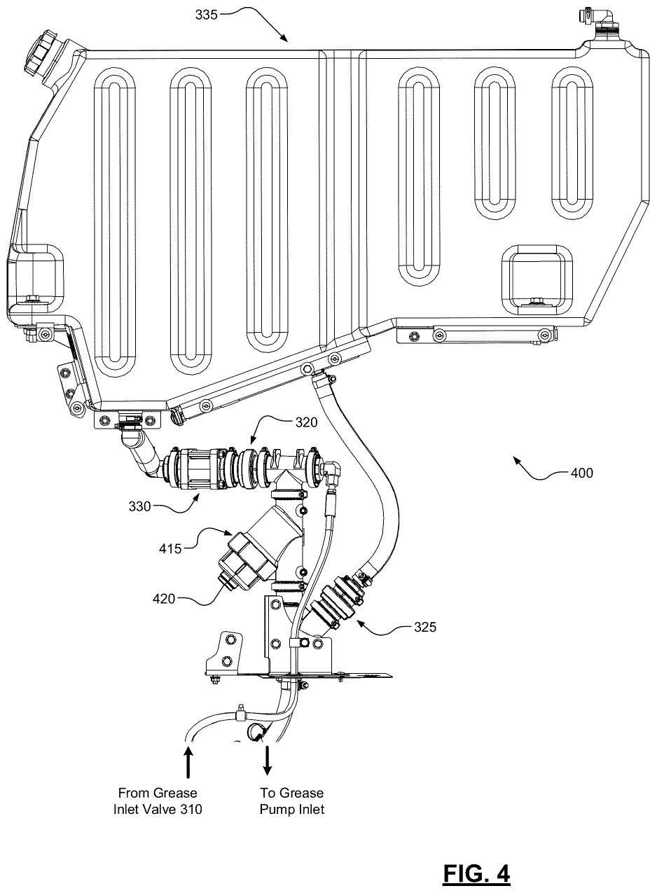

FIG. 3 is a functional block diagram of an example grease straining system, lubrication straining system 300, for use in/with lubrication system 200. FIG. 4 is an illustration of example implementation 400 of the lubrication straining system 300. Referring to FIGS. 3 and 4, the straining system 300 includes an inlet cap 305 that is connected to one end of an inlet valve 310. The second end of the inlet valve 310 is connected to both a first end of a strainer 315 and a first end of a supply check valve 320. A second end of the strainer 315 is connected to a first end of a fill valve 325, as well as an inlet of the pump 204. A second end of the filling valve 325 is connected to the reservoir 206. A first port of a service valve 330 is connected to a second end of the supply check valve 320 and a second port of the service valve 330 is connected to reservoir 206.

In various implementations, the inlet valve 310 and the supply valve 325 are spring loaded check valves. The inlet valve 310 may have a relatively high cracking pressure in comparison to the cracking pressure of the filling valve 325. For example, the inlet valve 310, may have a cracking pressure of 20-30 pound per square inch (PSI), while the filling valve 325 may have a cracking pressure of 1 PSI. In such implementations, the filling check 325 prevents grease from being pulled directly from the reservoir 206 by the pump 204—i.e., by-passing the strainer 315. In addition, the use of check values reduces or eliminates the generation of partial vacuums when grease is being drawn from the reservoir 206 by the pump 204.

As shown in FIG. 4, the strainer 315 may be a Y-strainer 415. In other implementations, the strainer 315 may be any other type of suitable strainer—for example, a T-strainer. The use of the Y-strainer 415 in the lubrication straining system 300 permits increased flow rates—for example, in comparison to a T-strainer. As shown in FIG. 4, the Y-strainer 315 includes a drain 420. The drain 420 may be used to prime the lubrication straining system 300 or perform diagnostics on the lubrication straining system 300. Additionally, the drain 420 may be used to clean out lubrication straining system 300 without having to fully open/disassemble the strainer 315.

An operator of the cotton picker 15 may load the lubrication straining system 300 with grease via the inlet valve 310. As grease is fed through the inlet valve 310, the grease is forced through the strainer 315 and then flows to both the pump 204 and the fill valve 325. During filling, the operator may open the bleeder valve of the pump 204 to permit any trapped air to escape, thus allowing the grease to fill cavities. Once a steady stream of grease is detected, the bleeder valve may be closed, resulting in the flow of grease to be redirected solely through the fill valve 325.

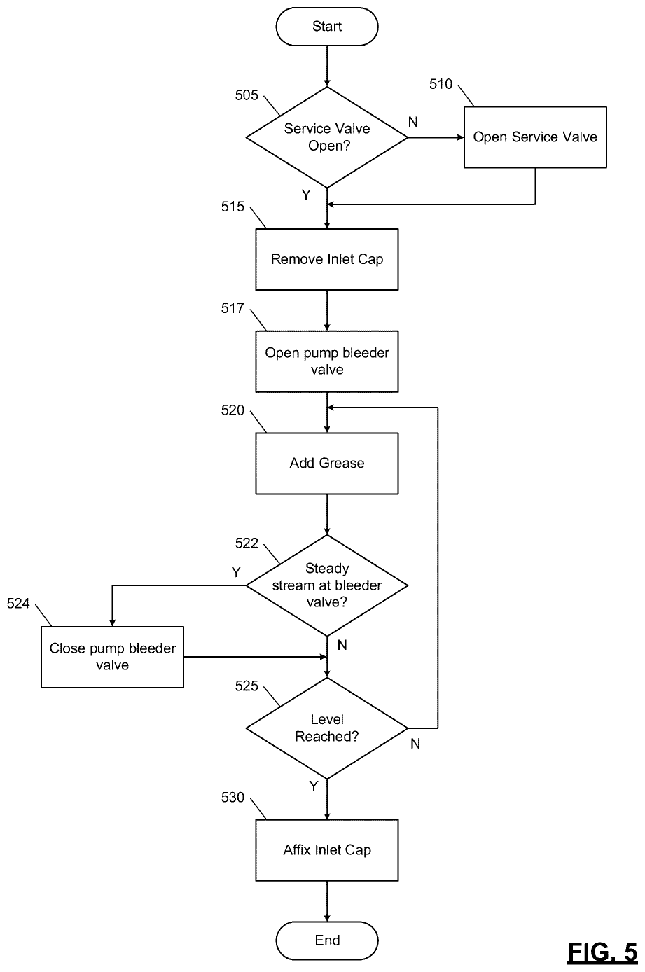

FIG. 5 is a flowchart depicting an example method of using the lubrication straining system 300 to load grease onto the cotton picker 15. In various implementations, the method depicted in FIG. 5 may be performed by one or more operators of the cotton picker 15. At 505, the state of the service valve 330 is determined. If the service valve 330 is closed, it is opened at 510; otherwise, the inlet cap 305 is removed to expose the inlet valve 310, at 515.

At 517, the bleeder valve of the pump 204 is opened. At 520, grease is introduced into lubrication straining system 300 via the inlet valve 310 and travels through the strainer 315 and then to the reservoir 206, via the filling valve 325, and to the pump 204.

At 522, the output of the bleeder valve of the pump 204 is determined. If a steady stream of grease is present at the bleeder valve, the bleeder valve is closed at 524. Once the desired amount of lubricant has been transferred to the reservoir 206, the inlet cap 305 is reattached to the inlet valve 310 at 530.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

In this application, the term “or” is used in its inclusive sense—i.e., a non-exclusive logical OR—so that when used, for example, to connect a list of elements, the term “or” means one, some, or all of the elements in the list. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

What is claimed is:

1. A lubrication system for a cotton harvester, the system comprising:
an inlet configured to receive lubricant from an external source;
a cap removably coupled to the inlet;
a reservoir configured to store the lubricant;
a fill valve having a first end and a second end, wherein the second end of the fill valve is coupled to the reservoir;
a strainer having a first end coupled to the inlet and a second end coupled to the first end of the fill valve; and
a supply valve having a first end coupled to the first end of the strainer and a second end configured to receive grease from the reservoir.

2. The lubrication system of claim 1, further comprising a service valve having a first port coupled to the reservoir and a second port coupled to the second end of the supply valve.

3. The lubrication system of claim 1, wherein the fill valve is configured to (i) permit a flow of fluid from the first end of the fill valve to the second end of the fill valve and (ii) restrict the flow of fluid from the second end of the fill valve to the first end of the fill valve.

4. The lubrication system of claim 3, wherein the supply valve is configured to (i) permit a flow of fluid from the first end of the supply valve to the second end of the supply valve and (ii) restrict the flow of fluid from the second end of the supply valve to the first end of the supply valve.

5. The lubrication system of claim 4, further comprising a pump (i) having an inlet coupled to the second end of the strainer and (ii) configured to supply the grease to a plurality of picking units of the cotton harvester.

6. The lubrication system of claim 1, wherein the fill valve includes a first spring loaded check valve.

7. The lubrication system of claim 6, wherein the inlet includes a second spring loaded check valve.

8. The lubrication system of claim 7, wherein the first spring loaded check valve has a first cracking pressure, the second spring loaded check valve has a second cracking pressure, and the second cracking pressure is greater than the first cracking pressure.

9. The lubrication system of claim 8, wherein the first cracking pressure is 1 pound per square inch (PSI).

10. The lubrication system of claim 8, wherein the second cracking pressure is 20-30 pounds per square inch (PSI).

11. The lubrication system of claim 1, wherein the strainer includes a Y-strainer.

12. The lubrication system of claim 9, wherein the Y-strainer includes a drain.

13. A method of operating a lubrication system of a cotton harvester having a plurality of picking units, a reservoir, and a pump configured to draw grease from the reservoir and supply it to the plurality of picking units, the method comprising:
opening a service valve coupled to the reservoir;
removing a cap covering an inlet;
opening a bleeder valve of the pump; and
adding the grease to the reservoir via the inlet.

14. The method of claim 13, further comprising:
monitoring an output of the bleeder valve;
closing, in response to determining that the output is a steady stream, the bleeder valve;
monitoring a level of grease in the reservoir;
in response to determining that the level is equal to a threshold value, (i) discontinuing the addition of grease via the inlet and (ii) affixing the cap to the inlet.

15. A cotton harvester comprising:
a plurality of picking units;
an inlet configured to receive grease from an external source;
a cap removably coupled to the inlet;
a reservoir configured to store the grease;
a fill valve having a first end and a second end, wherein the second end of the fill valve is coupled to the reservoir;
a strainer having a first end coupled to the inlet and a second end coupled to the first end of the fill valve;
a supply valve having a first end coupled to the first end of the strainer and a second end configured to receive grease from the reservoir; and
a pump (i) having an inlet coupled to the second end of the strainer and (ii) configured to supply the grease to the plurality of picking units.

16. The cotton harvester of claim 15, further comprising a service valve having a first port coupled to the reservoir and a second port coupled to the second end of the supply valve.

17. The cotton harvester of claim 16, wherein the fill valve includes a first spring loaded check valve and the inlet includes a second spring loaded check valve.

18. The cotton harvester of claim 17, wherein the first spring loaded check valve has a first cracking pressure, the second spring loaded check valve has a second cracking pressure, and the second cracking pressure is greater than the first cracking pressure.

19. The cotton harvester of claim 18, wherein the second cracking pressure is 20-30 pounds per square inch (PSI).

20. The cotton harvester of claim 15, wherein the strainer includes a Y-strainer.
